(19) United States
(12) Patent Application Publication
(10) Pub. No.: US 2022/0130266 A1
(43) Pub. Date: Apr. 28, 2022

(54) METHOD AND APPARATUS FOR VISUALIZING AND INTELLIGENTLY GUIDING GENERAL PROBLEM-SOLVING PROCESSES

(71) Applicant: Chengdu Hanqing Technology Co., Ltd., Chengdu City (CN)

(72) Inventors: Erqiang ZHOU, Chengdu City (CN); Ying SIMA, Chengdu City (CN)

(21) Appl. No.: 17/510,298

(22) Filed: Oct. 25, 2021

(30) Foreign Application Priority Data
Oct. 26, 2020 (CN) 202011158822.4

(51) Int. Cl. G09B 5/06; G06F 9/451; G06F 40/30; G06F 16/904

(52) U.S. Cl. CPC G09B 5/065; G06F 16/904; G06F 40/30; G06F 9/453

(57) ABSTRACT

A method and apparatus for enabling visualization of and intelligently guiding general problem-solving processes are provided. The method includes: generating key descriptions and non-key descriptions of each part based on a problem stem of a problem, knowledge points involved in the problem, and solving steps of the problem to form an atomic description set; classifying the descriptions in the atomic description set and generating relationships between the descriptions to form a system relationship set; generating, based on the descriptions in the atomic description set and corresponding categories, a basic graphic corresponding to each description and a basic graphic corresponding to each category to form a basic graphic set; generating feedback prompts corresponding to each relationship in the system relationship set to form a feedback prompt set; generating a user relationship set through interaction between a user and a system; and comparing the system relationship set and user relationship set.

### CROSS REFERENCE TO RELATED APPLICATION(S)

This patent application claims the benefit under 35 U.S.C. § 119 of Chinese Patent Application No. 202011158822.4 filed on Oct. 26, 2020, the entire contents of which are incorporated by reference herein as part of the present application

### TECHNICAL FIELD

The present disclosure relates to the field of intelligent teaching, and in particular, to a method and apparatus for enabling visualization of and intelligently guiding general problem-solving processes.

### BACKGROUND ART

Traditionally, problem-solving processes are manually guided (for example, through online tutoring and offline tutoring), or displayed by using static text and charts (such as books and web pages), recorded videos, audio, and the like. Such methods have the disadvantages in that manual guidance of problem-solving processes entails personnel with relevant knowledge. That is, the personnel who guides problem-solving processes must be highly proficient in professional knowledge. Offline tutoring cannot be rapidly promoted on a large scale, and is inefficient. Online tutoring with live or recorded broadcasting as a main method is merely a manual tutoring method with the Internet as a medium. Although this method can be promoted on a large scale, it cannot provide personalized guidance and communication with users in time. Also, the static text and charts, video and audio methods cannot interact with users, who can only receive and understand the corresponding text and charts passively. Therefore, static contents are less effective in inspiring and guiding users' problem-solving thoughts.

Currently, although there are some methods for guiding problem-solving processes, the methods belong to automatic guidance technologies targeted only for objective problem-solving processes and generally only for choice problems. These technologies simply determine whether a user's option is the same as an answer to further provide specific prompts and feedback instead of decomposing knowledge points of a problem. Essentially, this kind of methods let the user guess the answer. Such technologies do not truly implement intelligent guidance of problem-solving processes.

### SUMMARY

The present disclosure proposes a method and apparatus for intelligently guiding general problem-solving processes to solve the problems where manual tutoring has low efficiency and that existing automatic guidance technologies are only for objective choice problems, and for enabling visualization of the problem-solving processes.

The present disclosure describes technical solutions provided by the method and apparatus. A method for enabling visualization of and intelligently guiding general problem-solving processes includes:

atomic description set generation: generating key descriptions and non-key descriptions of each part based on a problem stem of a problem, knowledge points involved in the problem, and solving steps of the problem to form an atomic description set;

system relationship set generation: designing a description classification rule based on the problem stem of the problem, the knowledge points involved in the problem, and the solving steps of the problem, classifying the descriptions in the atomic description set, and generating relationships between each description and each category and between the descriptions to form a system relationship set;

basic graphic set generation: generating a basic graphic corresponding to each description and a basic graphic corresponding to each category based on the descriptions in the atomic description set and a category corresponding to each description to form a basic graphic set;

feedback prompt set generation: generating feedback prompts corresponding to each relationship in the system relationship set based on the problem stem of the problem, the knowledge points involved in the problem, and the solving steps of the problem to form a feedback prompt set;

user relationship set generation: performing, by a user, operations on basic graphics displayed on a human-machine interaction interface to create or update relationships between the basic graphics, to form a user relationship set; and

comparison: comparing the system relationship set and user relationship set, and providing feedback to the human-machine interaction interface based on a comparison result.

Further, the atomic description set generation specifically includes:

decomposing elements of the problem stem and extracting key problem stem descriptions and non-key problem stem descriptions;

sorting out key knowledge points required to solve the problem and decomposing the key knowledge points into key knowledge point descriptions at a knowledge cognitive level required for the user to solve the problem;

sorting out non-key knowledge points that are related to the problem but do not need to be used in solving the problem, and decomposing the non-key knowledge points into non-key knowledge point descriptions at the knowledge cognitive level required for the user to solve the problem;

logically dividing each of a plurality of solving steps in each solving method of the problem, wherein the division process may be a recursive process, that is, a solving process is sorted out from a highest level to form the plurality of solving steps, and then each solving step is logically divided to form solving substeps corresponding to the solving step until all the solving steps are logically divided; and

assigning a unique category number to each category of the key problem stem descriptions, the non-key problem stem descriptions, the key knowledge point descriptions, the non-key knowledge point descriptions, solving step descriptions, and non-solving step descriptions, and recording a subordinate relationship between each description and a category of the description.

Further, the atomic description set generation specifically includes:

collecting and sorting out various problems and a plurality of solving steps and related knowledge points corresponding to each problem, and saving problem stems, the solving steps, and the related knowledge points in a computer-processable manner to form a problem data set;

dividing the problem data set into three parts: a training set, a test set, and a to-be-processed problem set;

preprocessing and then performing semantic role labeling on the problem stems, solving steps, and related knowledge points in the training set and the test set, wherein meanings of labeled categories comprise a key problem stem description, non-key problem stem description, key knowledge point description, non-key knowledge point description, solving step description, and non-solving step description;

training a semantic role labeling model by using the training set, checking a training effect by using the test set, and stopping training when a specific threshold is reached for the training set;

performing semantic role labeling on the to-be-processed problem set by using the trained model; and

assigning a unique category number to each semantic role labeling category and recording a subordinate relationship between each semantic role label and a category of the semantic role label.

Further, the system relationship set generation specifically includes:

designing the description classification rule based on the problem stem of the problem, the knowledge points involved in the problem, and the solving steps of the problem, classifying the descriptions in the atomic description set, and generating a relationship between each description in the atomic description set and each category; and

selecting two descriptions from the atomic description set, determining a relationship between the two selected descriptions, and repeating the selection process until a relationship between any two descriptions in the atomic description set is determined; or

the system relationship set generation specifically comprises:

classifying the descriptions in the atomic description set;

determining a relationship between any two descriptions in each category;

determining a relationship between any two categories;

selecting two descriptions m1 and m2 in any two different categories A and B, respectively, wherein m1 belongs to the category A and m2 belongs to the category B, and if a relationship between the category A and category B is r, a relationship between m1 and m2 is also r, and adding the relationship r between m1 and m2 to the system relationship set; and

repeating the foregoing steps until a size of the system relationship set no longer changes.

Further, the basic graphic set generation specifically includes:

designing a respective basic graphic for each of the key problem stem descriptions, the non-key problem stem descriptions, the key knowledge point descriptions, the non-key knowledge point descriptions, the solving step descriptions, the non-solving step descriptions, and other categories of descriptions obtained based on the description classification rules, assigning a globally unique number to each graphic, and saving one-to-one correspondences between each description and a corresponding graphic and between each category and a corresponding graphic; or

designing basic graphics of various descriptions and categories and saving them in a graphic library in advance, selecting basic graphics corresponding to the obtained descriptions and categories from the graphic library, assigning a globally unique number to each of the selected graphics, and saving relationships between each description and a corresponding graphic and between each category and a corresponding graphic.

Further, the feedback prompt set generation specifically includes:

checking whether each relationship in a relationship name set can be independent of the problem and uniformly use a feedback prompt; and if yes, using a feedback prompt that has been designed for the problem or redesigning the feedback prompt of the relationship; or if no, designing respective feedback prompts for each relationship in the category; wherein display forms of the designed feedback prompts comprise but are not limited to text, graphics, images, formulas, expressions, symbols, strings, audio, videos, and animations, and a relationship can have any number of feedback prompts.

Further, the user relationship set generation specifically includes:

displaying all or some of graphics in the basic graphic set and corresponding atomic descriptions on the human-machine interaction interface based on one-to-one correspondences between the atomic description set and the basic graphic set;

performing, by the user, operations on the basic graphics displayed on the human-machine interaction interface to create or update the relationships between the basic graphics; and

determining, based on the relationships between the basic graphics edited by the user and the one-to-one correspondences between the atomic description set and the basic graphic set, relationships between the descriptions edited by the user, to form the user relationship set.

Further, the comparison specifically includes:

comparing, by a system, the user relationship set with the system relationship set when the user performs operations on the basic graphics, to obtain the comparison result; and

determining, based on the comparison result and the feedback prompt set, categories, a number, positions, and display modes of feedback prompts that need to be displayed, and displaying the feedback prompts on the human-machine interaction interface with reference to user preference settings and problem difficulty settings.

Further, the comparing the system relationship set and user relationship set includes: if the user relationship set on the current human-machine interaction interface is a subset of the system relationship set, completing problem solving.

An apparatus for enabling visualization of and intelligently guiding general problem-solving processes, including: an atomic description set generation module, a basic graphic set generation module, a system relationship set generation module, a feedback prompt set generation module, a user relationship set generation module, a comparison module, and a human-machine interaction module; wherein

the atomic description set generation module is configured to generate key descriptions and non-key descriptions of each part based on a problem stem of a problem, knowledge points involved in the problem, and solving steps of the problem to form an atomic description set;

the basic graphic set generation module is configured to generate a basic graphic corresponding to each description based on the descriptions in the atomic description set to form a basic graphic set based on all the basic graphics;

the system relationship set generation module is configured to generate relationships between the descriptions in the atomic description set based on the problem stem of the problem, the knowledge points involved in the problem, and the solving steps of the problem to form a system relationship set;

the feedback prompt set generation module is configured to generate feedback prompts corresponding to each relationship in the system relationship set based on the problem stem of the problem, the knowledge points involved in the problem, and the solving steps of the problem to form a feedback prompt set;

the user relationship set generation module is configured to perform, by a user, operations on the basic graphics displayed on a human-machine interaction interface to create relationships between the basic graphics, to form a user relationship set;

the comparison module is configured to compare the system relationship set and user relationship set, and provide feedback to the human-machine interaction interface based on a comparison result; and

the human-machine interaction module is configured to display the atomic description set generation module, basic graphic set generation module, system relationship set generation module, feedback prompt set generation module, user relationship set generation module, and comparison module, and click, drag, move, connect, zoom, and delete the basic graphics on the human-machine interaction interface by the user.

The method and apparatus disclosed in this application have technical benefits. A method and apparatus for intelligently guiding and enable visualization of general problem-solving processes effectively improve learning efficiency and reduce learning costs of users, can decompose knowledge points, and are applicable to visual solving and guidance of various problems or problems that students need to solve or exercise in learning processes at various stages such as primary school, middle school, college, and adult education. Various embodiments include specifically designed graphical user interfaces that reduce time to complete a task and improve computer-aided learning and problem-solving.

### BRIEF DESCRIPTION OF THE DRAWINGS

To describe the technical solutions in the embodiments more clearly, the accompanying drawings required for the embodiments will be briefly described below. The accompanying drawings described below illustrate merely some embodiments in the present disclosure, and a common person skilled in the art may also obtain other accompanying drawings based on these accompanying drawings without creative efforts.

FIG. 1 is a schematic diagram of a method for enabling visualizing and intelligently guiding general problem-solving processes according to the present disclosure;

FIG. 2 is a schematic diagram of an apparatus for enabling visualizing and intelligently guiding general problem-solving processes according to the present disclosure.

### DETAILED DESCRIPTION OF THE EMBODIMENTS

### Embodiment 1

General problems in the present disclosure generally refer to various problems or problems that students need to solve or exercise in learning processes at various stages such as primary school, middle school, college, and adult education.

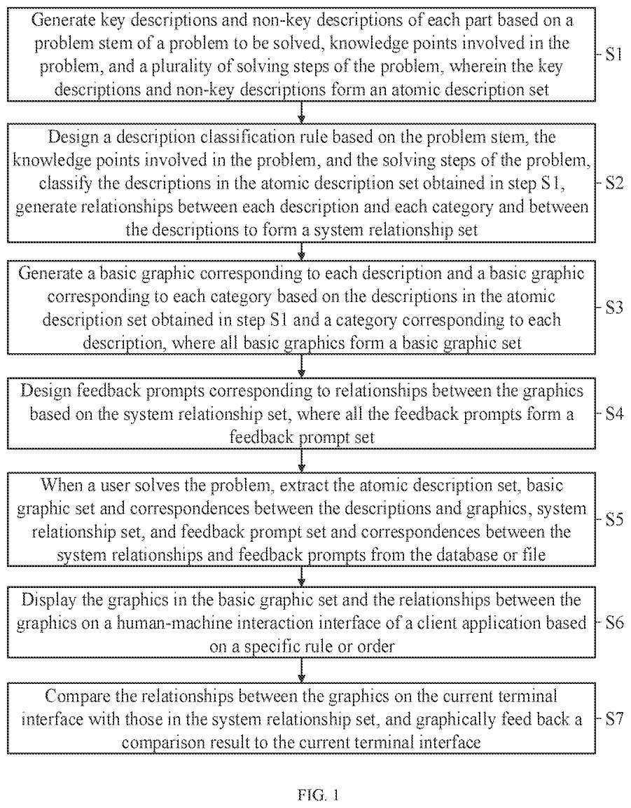

The present disclosure is specifically directed to a method for enabling visualizing and intelligently guiding general problem-solving processes, including the following steps, as illustrated in FIG. 1.

S1: key descriptions and non-key descriptions of each part are generated based on a problem stem of a problem to be solved, knowledge points involved in the problem, and a plurality of solving steps of the problem. Forms of the key descriptions or non-key descriptions include but are not limited to text, graphics, formulas, expressions, symbols, strings, and so forth. The key descriptions and non-key descriptions form an atomic description set. The atomic description herein means that the description cannot be divided at a corresponding thinking level. The atomic description set is saved in a database or file.

S2: a description classification rule is designed based on the problem stem, the knowledge points involved in the problem, and the solving steps of the problem, the descriptions in the atomic description set obtained in step S1 is classified, relationships between each description and each category and between the descriptions are generated to form a system relationship set, and the system relationship set is saved in the database or file.

S3: a basic graphic corresponding to each description and a basic graphic corresponding to each category are generated based on the descriptions in the atomic description set obtained in step S1 and a category corresponding to each description, where all basic graphics form a basic graphic set, and the basic graphic set and correspondences between the descriptions and graphics are saved in the database or file.

S4: feedback prompts corresponding to relationships between the graphics are designed based on the system relationship set, where all the feedback prompts form a feedback prompt set, and the feedback prompt set and correspondences between the system relationships and feedback prompts are saved in the database or file.

S5: When a user solves the problem, the atomic description set, basic graphic set and correspondences between the descriptions and graphics, system relationship set, and feedback prompt set and correspondences between the system relationships and feedback prompts are extracted from the database or file, and these data are loaded to a local machine of the user.

S6: the graphics in the basic graphic set and the relationships between the graphics are displayed on a human-machine interaction interface of a client application based on a specific rule or order.

S7: the relationships in the system relationship set are classified and displayed on the terminal interface. The user performs operations on the graphics, for example, clicks, drags, moves, connects, zooms, and deletes the graphics on the terminal interface to create, update, and delete the relationships between the graphics, which form a user relationship set. The relationships between the graphics on the current terminal interface are compared with those in the system relationship set, and a comparison result is graphically fed back to the current terminal interface. If the user relationship set on the current terminal interface is a subset of the system relationship set, problem-solving is completed.

Key problem stem descriptions refer to descriptions that play a key role in (or have great contributions to) sorting out a solving process of the problem (or solving the problem) in problem stem descriptions. The problem cannot be completely solved or the solving process of the problem cannot be sorted out without the key problem stem descriptions or without using the key problem stem descriptions.

Non-key problem stem descriptions refer to descriptions that are not closely related to sorting out the solving process of the problem (or solving the problem) in the problem stem descriptions. The problem can be completely solved or the solving process of the problem can be sorted out even without these descriptions.

Key knowledge points refer to knowledge points required to completely sort out the solving process of the problem or solve the problem. The problem cannot be completely solved or the solving process of the problem cannot be sorted out without these knowledge points or without using these knowledge points. If the problem can be solved in a plurality of ways, knowledge points involved in each solving method form a key knowledge point set of the problem.

Non-key knowledge points refer to knowledge points related to the problem but not the foregoing key knowledge points. The problem can be completely solved or the solving process of the problem can be sorted out even without using the non-key knowledge points.

Human-machine interaction interface is also referred to as a terminal interface, i.e., an operation interface for interaction between a user and a device. The device herein refers to a computing device or a computer, and is an intelligent electronic device that can perform predetermined processing such as numerical computing and/or logic computing by running predetermined programs or instructions. The device may include a processor and a memory. Pre-stored instructions in the memory are executed by the processor, hardware such as an application-specific integrated circuit (ASIC), a field-programmable gate array (FPGA), or a digital signal processor (DSP), or a combination of the processor and hardware to perform predetermined processing. The computing device includes but is not limited to a server, a personal computer, a notebook computer, a tablet computer, a smartphone, a learning machine, a tutoring machine, a personal digital assistant (PDA), etc.

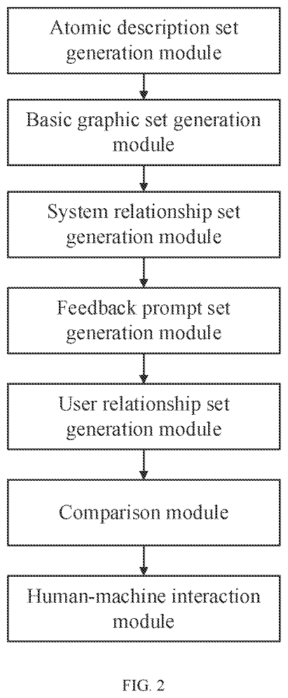

As illustrated in FIG. 2, an apparatus for enabling visualization of and intelligently guiding general problem-solving processes can include an atomic description set generation module, a basic graphic set generation module, a system relationship set generation module, a feedback prompt set generation module, a user relationship set generation module, a comparison module, and a human-machine interaction module.

### Embodiment S1-1

This embodiment is a further implementation of step S1 on the basis of embodiment 1, and may include the following steps.

S11: Text, graphics, images, formulas, expressions, symbols, strings, and the like that appear in the problem stem are decomposed to extract key problem stem descriptions that have a positive inspiration effect for solving the problem. Forms of the key problem stem descriptions include but are not limited to text, graphics, formulas, expressions, symbols, and strings, among other things.

S12: The text, graphics, images, formulas, expressions, symbols, strings, and the like that appear in the problem stem are decomposed to extract non-key problem stem descriptions that are not related to or have no inspiration effect for solving the problem. Forms of the non-key problem stem descriptions include but are not limited to text, graphics, formulas, expressions, symbols, and strings, among other things.

S13: Key knowledge points required to solve the problem are sorted out, and the key knowledge points are decomposed into key knowledge point descriptions at a knowledge cognitive level required for the user to solve the problem. Forms of the key knowledge point descriptions include but are not limited to text, graphics, images, formulas, expressions, symbols, and strings, among other things.

S14: Non-key knowledge points that are related to the problem but do not need to be used in solving the problem are sorted out, and the non-key knowledge points are decomposed into non-key knowledge point descriptions at the knowledge cognitive level required for the user to solve the problem. Forms of the non-key knowledge point descriptions include but are not limited to text, graphics, images, formulas, expressions, symbols, and strings, among other things.

S15: Each of a plurality of solving steps in each solving method of the problem is logically divided. This step may specifically include the following steps:

S151: Assigning a globally unique number to the solving step.

S152: Summarizing and condensing the solving step into a solving step description, where forms of the solving step description include but are not limited to text, graphics, images, formulas, expressions, symbols, and strings, among other things.

S153: Performing knowledge expansion on the solving step and obtaining, through condensation, non-solving step descriptions that are logically correct but have nothing to do with solving the problem.

S154: Recording the number corresponding to the step, and a number, solving step descriptions, and non-solving step descriptions of a higher-level solving step; if the solving step can be decomposed into a plurality of solving substeps, repeating steps S151 to S153 for each solving substep of the solving step until each solving substep can no longer be divided.

S16: Assigning a unique category number to each category of description generated in steps S11, S12, S13, S14, and S15, assigning a globally unique description number to each description in the four categories of descriptions, recording a subordinate relationship between each description and a category of the description, where the obtained descriptions form the atomic description set, and saving the atomic description set to the database or file.

For example, the problem is as follows: if tan(x)=2 is known, calculate the value of sin(x)cos(x).

The key problem stem descriptions obtained in step S11 are as follows: calculate the value of sin(x)cos(x) and tan(x)=2.

The non-key problem stem descriptions obtained in step S12 are empty.

The key knowledge point descriptions obtained in step S13 are as follows: sin²x+cos² x=1,

$$tan α = \frac{sin α}{cos α} ,$$

and if the numerator or denominator is 1, replace 1 with sin²x+cos²x.

The non-key knowledge point descriptions obtained in step S14 are as follows: Trigonometric functions are all positive in the first quadrant, sin α=cos α tan α, and 1 in 1±2 sin(x)cos(x) can be replaced by sin(x+cos²x, and the original expression can be changed to (sin(x)±cos(x))².

The solving step description obtained in step S151 is as follows: equivalently transform sin(x)cos(x) into an expression that contains tan(x). This step can be decomposed into the following substeps: transform sin(x)cos(x) into

$$\frac{sin ( x ) cos ( x )}{1} ,$$

replace 1 with sin²x+cos²x, and divide both the numerator and denominator by cos²x.

The non-solving step descriptions obtained in step S152 are as follows: find the period of sin(x)cos(x) and draw the image of sin(x)cos(x).

### Embodiment S1-2

This embodiment is another further implementation of step S1 on the basis of embodiment 1, and may include the following steps:

S11: Various problems and a plurality of solving steps and related knowledge points corresponding to each problem are collected and sorted out, and problem stems, the solving steps, and the related knowledge points in a computer-processable manner, for example, as strings, vector diagrams, or images are saved to form a problem data set.

S12: The problem data set is divided into three parts: a training set, a test set (or a validation set), and a to-be-processed problem set.

S13: The problem stems, solving steps, and related knowledge points in the training set and test set are preprocessed and then are subjected to semantic role labeling. Meanings of label categories include but are not limited to a key problem stem description, non-key problem stem description, key knowledge point description, non-key knowledge point description, solving step description, non-solving step description, and the like. It should be noted that for the sake of simplicity, specific semantic categories or label categories are generally represented by using only specific letters, numbers, or characters, instead of directly using the meanings of the label categories, during semantic labeling. During actual labeling, there are many forms of symbols used to label or represent semantic categories, and examples are not listed herein.

S14: A new semantic role labeling algorithm is designed or an existing semantic role labeling algorithm is employed, a semantic role labeling model is trained by using the training set, a training effect may be checked by using the test set, and training is stopped when a specific threshold is reached for the training set.

S15: The model obtained in step S14 in this embodiment is used to perform semantic role labeling on the to-be-processed problem set. In another optional implementation, semantic role labeling results obtained through the labeling are manually modified. A semantic role labeling category is a category of a description, and labeled content is the description.

S16: A unique category number is assigned to each semantic role labeling category (namely, each category of description), a globally unique description number is assigned to each semantic role labeling result (namely, each description), record a subordinate relationship between each description and a category of the description, where the obtained descriptions form the atomic description set, and the atomic description set is saved into the database or file.

It should be noted that the key problem stem description, non-key problem stem description, key knowledge point description, non-key knowledge point description, solving step description, and non-solving step description mentioned in the embodiments S1-1 and S1-2 of the present disclosure are merely names used for illustration. These names can be replaced by other names, and examples are not listed herein.

### Embodiment S2

This embodiment is another further implementation of step S2 on the basis of embodiment 1, and may include the following steps.

S21: The description classification rule is designed, the descriptions in the atomic description set is classified, the relationship between each description and each category is determined, based on obtained new categories and the six categories (key problem stem description, non-key problem stem description, key knowledge point description, non-key knowledge point description, solving step description, and non-solving step description) obtained in step S1, and all such relationships are denoted as R1.

In the present disclosure, the relationship between each description and each description category is a subordinate relationship or an inclusion relationship. Relationships between the descriptions include but are not limited to a reasoning relationship, a causal relationship, a subordinate relationship, an inclusion relationship, a parallel relationship, a sequential relationship, a preorder relationship, a postorder relationship, a whole-part relationship, an independent relationship and the like. In particular, if two descriptions are independent of each other, that is, have no relationship such as a reasoning, causal, subordinate, inclusion, parallel, sequence, preorder, postorder, or whole-part relationship, the relationship between the two descriptions is an independent relationship.

S22: The atomic description set is denoted as K, the relationships between the descriptions in the set K are determined, and all these relationships are denoted as R2.

S23: In another optional implementation, the descriptions in the atomic description set is classified based on the description classification rule to obtain new description categories C₁, C₂, C₃, . . . , Cₙ₋₁, and Cₙ, and relationships between descriptions of the new categories is determined. For example, a relationship between each description in C₁ and each description in C₂, C₃, . . . , Cₙ₋₁, and Cₙ is firstly determined; a relationship between each description in C₂ and each description in C₃, . . . , Cₙ₋₁, Cₙ is determined; a relationship between each description in C₃ and each description in C₄, . . . , Cₙ₋₁, and Cₙ is determined; . . . ; then a relationship between each description in Cₙ₋₂ and each description in Cₙ₋₁ and Cₙ is determined; then a relationship between each description in Cₙ₋₁ and each description in Cₙ is determined; and finally, a set of the relationships between all the descriptions are denoted as R2.

S24: In another optional implementation, relationships between the key problem stem descriptions, non-key problem stem descriptions, key knowledge point descriptions, non-key knowledge point descriptions, solving step descriptions, and non-solving step descriptions may be determined separately. For example, a relationship between each description in the key problem stem description and each description in other categories of descriptions (including the non-key problem stem descriptions, key knowledge point descriptions, non-key knowledge point descriptions, solving step descriptions, and non-solving step descriptions) is firstly determined, and each description in the non-key problem stem descriptions and each description in the key knowledge point descriptions, non-key knowledge point descriptions, solving step descriptions, and non-solving step descriptions is then determined; next, a relationship between each description in the key knowledge point descriptions and each description in the non-key knowledge point descriptions, solving step descriptions, and non-solving step descriptions is determined; a relationship between each description in the non-key knowledge point descriptions and each description in the solving step descriptions and non-solving step descriptions is determined; then a relationship between each description in the solving step descriptions and each description in the non-solving step descriptions is determined; and finally, a set of the relationships between all the descriptions are denoted as R2.

S25: Relationships between the relationships in the set R2 are determined and a set of the relationships are denoted as R3. In the present disclosure, the relationships between the relationships include but are not limited to a reasoning relationship, a causal relationship, a subordinate relationship, an inclusion relationship, a parallel relationship, a sequence relationship, a preorder relationship, a postorder relationship, a whole-part relationship, and an independent relationship, among other things. In particular, if two descriptions are independent of each other, that is, have no relationship such as a reasoning, causal, subordinate, inclusion, parallel, sequence, preorder, postorder, or whole-part relationship, the relationship between the two descriptions is an independent relationship.

S26: The relationship sets R1, R2, and R3 are recorded and saved. Without loss of generality, a relationship can be represented by using a ternary expression <Number of a description A (or relationship A), Number of a description B (or relationship B), Relationship name>. All these relationships form the system relationship set.

### Embodiment S3

This embodiment is another further implementation of step S3 on the basis of embodiment 1, and may include the following steps.

S31: The descriptions in the atomic description set are classified based on the description classification rule to obtain the new description categories C₁, C₂, C₃, . . . , Cₙ₋₁, and Cₙ, basic graphics for each of the categories C₁, C₂, C₃, . . . , Cₙ₋₁, and Cₙ, as well as basic graphics for each description in the atomic description set are designed, a globally unique number is assigned to each graphic, and one-to-one correspondences between each category and a corresponding graphic, and between each description and a corresponding graphic are saved. The designed graphic may be a plane geometric figure, a three-dimensional geometric figure, or other forms of irregular graphics.

S32: In an optional implementation, various graphics may be designed in advance, including but not limited to plane geometric figures, three-dimensional geometric figures, or other forms of irregular graphics, and the designed graphics are saved to a graphic library; the steps S11, S12, S13, S14, and S15 are performed, and then a graphic corresponding to each of the obtained descriptions is selected from the graphic library; the descriptions in the atomic description set are classified based on the description classification rule to obtain the new description categories C₁, C₂, C₃, . . . , Cₙ₋₁, and Cₙ, and graphics corresponding to the categories C₁, C₂, C₃, . . . , Cₙ₋₁, and Cₙ are selected from the graphic library; and a globally unique number is assigned to each of the selected graphics, and relationships between each category and a corresponding graphic, and each description and a corresponding graphic are saved.

S33: In another optional implementation, the graphics corresponding to the descriptions generated in steps S11, S12, S13, S14, and S15 are distinctively marked by category. Forms of distinctive marking include but are not limited to the following forms.

A first form of distinctive marking is to set different background colors or fill colors for graphics corresponding to different categories. The background or fill colors can be completely or partially filled.

A second form of distinctive marking is to set different background color schemes or fill color schemes (such as red and blue schemes) for graphics corresponding to different categories, and different colors in a same color scheme for graphics in a same category. The background colors or fill colors can be completely or partially filled.

A third form of distinctive marking is to set different colors for edges of graphics corresponding to different categories. A color may be set for all or some edges of a graphic.

A fourth form of distinctive marking is to add different graphic or text marks to edges or vertices of, or inside graphics corresponding to different categories. A size of a graphic or text mark is generally significantly smaller than that of a marked graphic. One or more graphic or text marks can be added to each graphic in a same category, but a number and form of the added marks must be the same in the same category.

A fifth form of distinctive marking is to select a background image for each category and select an area from the background image corresponding to the category as a background image of each of all graphics in the category. A size of the background image is not limited, but is generally comparable to a size of the corresponding graphic. If the graphic is a three-dimensional figure, an area of the background image can be set for one or more outer surfaces of the three-dimensional figure, or any one or more planes inside the three-dimensional figure.

S34: In another optional implementation, graphics corresponding to the descriptions generated in steps S11, S12, S13, S14, and S15 are recombined and classified by category, and the graphics is subjected to distinctive marking based on new categories obtained after the recombination. Forms of distinctive marking include but are not limited to the four forms described in step S24. For example, graphics corresponding to the descriptions generated in steps S11 and S12 form a new category NG1; graphics corresponding to the descriptions generated in steps S13 and S14 form a new category NG2; and graphics corresponding to the descriptions generated in step S15 form a new category NG3. The new categories obtained after the recombination are NG1, NG2, and NG3. Then, the graphics are subjected to distinctive marking based on the new categories NG1, NG2, and NG3 obtained after the recombination.

S35: In another optional implementation, a uniform display manner is designed for the descriptions in the atomic description set. The uniform display manner includes but is not limited to the following manners.

A first uniform display manner is to design a graphic (such as a rectangle or an ellipse) for all descriptions, and then display the descriptions in blank areas of such graphics.

A second uniform display manner is to use an image as background images of all descriptions, that is, to display each description on the image.

A third uniform display manner is to use a description (including but not limited to text, a graphic, a formula, an expression, a symbol, or a string) to represent a graphic corresponding to the description, without attaching other graphics, images, or text.

A fourth uniform display manner is to attach a mark to each description. The mark includes but is not limited to text, a symbol, a graphic, a string, etc. The description and the mark corresponding to the description form a new combination to represent a graphic corresponding to the description, without attaching other graphics or text.

### Embodiment S4

This embodiment is another further implementation of step S4 on the basis of embodiment 1, and may include the following steps.

S41: Relationship names of the relationships are extracted from the system relationship set, and a set operation is performed on the extracted relationship names; that is, for duplicate relationship names, one relationship name is kept and other relationship names are deleted, to obtain a relationship name set.

S42: It is checked whether each relationship in the relationship name set can be independent of the problem and uniformly use a kind of (or a) feedback prompt; and if yes, a feedback prompt that has been designed for the problem or redesign the feedback prompt of this category of relationship may be used; or if no, feedback prompts for each relationship in this category are designed. Display forms of the designed feedback prompts include but are not limited to text, graphics, images, formulas, expressions, symbols, strings, audio, videos, animations and the like. For example, the feedback prompt may be an audio or video explanation of a reasoning relationship, an animated demonstration of a causal relationship, a text description of a sequential relationship, or a formula involved in an independent relationship. In addition, a relationship may involve any number of feedback prompts. If a relationship has a plurality of feedback prompts, the feedback prompts can be classified, for example, into a wrong feedback prompt, a correct feedback prompt, a missing feedback prompt, a redundant feedback prompt, and so on.

S43: The feedback prompts designed in step S42 and their categories are recorded into the relationships in the system relationship set; or the feedback prompts designed in S42 and their categories are separately numbered and recorded, and a feedback prompt number corresponding to each relationship is recorded into the relationship in the system relationship set.

S44: In an optional implementation, the feedback prompts designed in step S42 are unifiedly numbered and separately saved, the relationships in the system relationship set are unifiedly numbered, and a correspondence between a number of each system relationship and a number of each feedback prompt is recorded and saved.

### Embodiment S5

This embodiment is another further implementation of step S5 on the basis of embodiment 1, and may include the following steps:

S51: When the user solves the problem, it is checked whether the user locally has data such as the atomic description set, basic graphic set and correspondences between the descriptions and graphics, system relationship set, and feedback prompt set and correspondences between the system relationships and feedback prompts corresponding to the problem. If there is no such data locally, the data can be obtained from a server over a network and saved locally.

S52: In an optional implementation, the data such as the atomic description set, basic graphic set and correspondences between the descriptions and graphics, system relationship set, and feedback prompt set and correspondences between the system relationships and feedback prompts are packaged and compressed in a specific format, and the data together with a client application are issued. In this case, the application does not need to obtain relevant data from the server over the network.

S53: In another optional implementation, part of the data such as the atomic description set, basic graphic set and correspondences between the descriptions and graphics, system relationship set, and feedback prompt set and correspondences between the system relationships and feedback prompts are packaged and compressed in a specific format, then the part of the data together with a client application are issued, and the other part of the data is stored in the server. This can prevent loss of core data after the client program is maliciously cracked.

S54: In another optional implementation, the data such as the atomic description set, basic graphic set and correspondences between the descriptions and graphics, system relationship set, and feedback prompt set and correspondences between the system relationships and feedback prompts are packaged and compressed in a specific format, then the data are stored in the server, and required data are obtained from the server each time the user solves the problem, without setting a cache locally. In this way, it helps ensure that data used by the client is up to date.

### Embodiment S6

This embodiment is another further implementation of step S6 on the basis of embodiment 1, and may include the following steps:

S61: A number n of graphics displayed on the terminal interface is determined based on a size Y of the atomic description set and a size of the human-machine interaction interface (terminal interface) of the client application. The value of n can indirectly adjust the difficulty of the problem during process guidance. In an optional implementation, the value of n may be a value much greater than a general size of the atomic description set, such as 10000, such that almost all graphics in the basic graphic set corresponding to the problem can be displayed on the terminal interface at a time.

S62: If Y≤n, all the graphics in the basic graphic set on the terminal interface are displayed, otherwise, n graphics are selected from the basic graphic set based on a preset rule or sequence and displayed on the terminal interface. In this case, the rule or sequence of the selected graphics also affects the difficulty of the problem during process guidance. For the rule or sequence of selecting graphics, in an optional implementation, the n graphics are randomly selected from the graphic set and displayed on the terminal interface. In another optional implementation, the key and non-key problem stem descriptions are grouped into a group 1, the key and non-key knowledge point descriptions are grouped into a group 2, and the solving and non-solving step descriptions are grouped into a group 3, and graphics corresponding to the descriptions in each group are selected from the basic graphic set in a sequence of the group 1, group 2, and group 3. In another optional implementation, m (m>n) graphics may be selected from the basic graphic set based on a specific rule or sequence, and the m graphics are filtered based on the relationships in the system relationship set and one-to-one correspondences between the descriptions and graphics to obtain m1 (m1<m) graphics. If m1>n, first n graphics are selected from the m1 graphics and displayed on the terminal interface. Otherwise, a larger value of m (for example, 2×m) is selected, and the foregoing operations are repeated until a number of graphics after filtering is greater than or equal to n. Afterwards, first n graphics are selected from the graphics after filtering and displayed on the terminal interface.

S63: Descriptions corresponding to the displayed graphics on the terminal interface are displayed. In an optional implementation, the description may be displayed at a center or core position of the graphic. In another optional implementation, the description may be displayed on an inner side or outer side of an edge of the graphic. In another optional implementation, the description and the corresponding graphic may be displayed on the terminal interface in a relatively independent mode, and a relationship between them may be clarified in other ways. For example, when a mouse is moved over the graphic or the graphic is clicked via the mouse, the description corresponding to the graphic is highlighted, while other descriptions are not displayed or displayed in an inconspicuous color; and when the mouse is moved away or after a few seconds elapse, the original display state is restored. As another example, when the mouse is moved over the graphic or the graphic is clicked via the mouse, the relevant description is displayed near the graphic in a form of a prompt box; and when the mouse is moved away or after a few seconds elapse, the corresponding description is not displayed.

### Embodiment S7

This embodiment is another further implementation of step S7 on the basis of embodiment 1, and may include the following steps:

S71: The relationships in the system relationship set corresponding to the problem solved by the user are classified and counted by relationship name, and displayed on the terminal interface. In an optional implementation, in addition to the system relationship set corresponding to the problem solved by the user, relationships in system relationship sets corresponding to other problems may be added and displayed on the terminal interface to increase the difficulty of the problem during process guidance or as a supplement to the current problem relationships.

S72: Whether the user has solved the problem may be checked, and if no, the user relationship set is set to be empty; otherwise, relative positions of the displayed basic graphics are adjusted based on the saved user relationship set, and then the relationships in the user relationship set are displayed on the terminal interface.

S73: The user performs operations on the graphics, for example, clicks, drags, moves, connects, and deletes the graphics on the terminal interface to create, update, and delete the relationships between the graphics. Each time the user performs an operation, the client application or server service program compares a currently edited relationship with the relationship in the system relationship set, determines a category, such as correct, wrong, redundant, or missing, of the relationship based on the comparison result, and selects, based on the determined category of the relationship, an appropriate feedback prompt from feedback prompts corresponding to the relationship.

S74: In an optional implementation, the client application may allow the user to set a trigger mechanism of checking content of the current terminal interface, for example, check after clicking a button, check every specific period, or use a default checking rule of the system. When the user performs operations on the graphics, for example, clicks, drags, moves, connects, and deletes the graphics on the terminal interface to create, update, and delete the relationships between the graphics, the client application only records the user relationship set on the current terminal interface after the operations, and does not compare the elements of user relationship set with the system relationship set. When a check request is triggered, the client application either compares the current user relationship set with the system relationship set, or sends the current user relationship set to the server service program, and the server service program compares the user relationship set and system relationship set, and then returns the comparison result to the client application. The client application determines a category, such as correct, wrong, redundant, or missing, of each relationship on the current terminal interface based on the comparison result, and selects, based on the determined category of the relationship, an appropriate feedback prompt from feedback prompts corresponding to the relationship.

S75: The selected feedback prompt is displayed on the terminal interface. It should be noted that forms in which the feedback prompt is displayed include but are not limited to the following forms: (1) add a new graphic, text, or another element to the terminal interface. (2) change a relevant attribute of an element, such as an existing graphic or text, on the terminal interface, for example, change the background color of the graphic, change the color of edges of the graphic, change the size of the graphic, or change the color or size of text. (3) add a mark to an element, such as an existing graphic or text, on the terminal interface such that the graphic is differentiated from the original graphic.

S76: Steps S73, S74, and S75 are repeated; and if the user relationship set on the current terminal interface is a subset of the system relationship set, process guidance of the problem is completed. The user can further perform refinement based on the solving process on the terminal interface to complete problem-solving.

The forgoing descriptions are merely preferred implementations of the present disclosure, and should not be construed as excluding other embodiments. It should be understood that the present disclosure is not limited to the form disclosed herein, and can be used in various other combinations, modifications and environments. Modifications can be made within the scope of the concept described herein through the above teachings or techniques or knowledges in related fields. Modifications and changes made by those skilled in the art without departing from the spirit and scope of the present disclosure should fall within the protection scope of the appended claims of the present disclosure.

What is claimed is:

1. A method for enabling visualization of and intelligently guiding general problem-solving processes, comprising:
atomic description set generation: generating key descriptions and non-key descriptions of each part based on a problem stem of a problem, knowledge points involved in the problem, and solving steps of the problem to form an atomic description set;
system relationship set generation: designing a description classification rule based on the problem stem of the problem, the knowledge points involved in the problem, and the solving steps of the problem, classifying the descriptions in the atomic description set, and generating relationships between each description and each category and between the descriptions to form a system relationship set;
basic graphic set generation: generating a basic graphic corresponding to each description and a basic graphic corresponding to each category based on the descriptions in the atomic description set and a category corresponding to each description to form a basic graphic set;
feedback prompt set generation: generating feedback prompts corresponding to each relationship in the system relationship set based on the problem stem of the problem, the knowledge points involved in the problem, and the solving steps of the problem to form a feedback prompt set;
user relationship set generation: performing, by a user, operations on basic graphics displayed on a human-machine interaction interface to create or update relationships between the basic graphics, to form a user relationship set; and
comparison: comparing the system relationship set and user relationship set, and providing feedback to the human-machine interaction interface based on a comparison result.

2. The method for enabling visualization of and intelligently guiding general problem-solving processes according to claim 1, wherein the atomic description set generation specifically comprises:
decomposing elements of the problem stem and extracting key problem stem descriptions and non-key problem stem descriptions;
sorting out key knowledge points required to solve the problem and decomposing the key knowledge points into key knowledge point descriptions at a knowledge cognitive level required for the user to solve the problem;
sorting out non-key knowledge points that are related to the problem but do not need to be used in solving the problem, and decomposing the non-key knowledge points into non-key knowledge point descriptions at the knowledge cognitive level required for the user to solve the problem;
logically dividing each of a plurality of solving steps in each solving method of the problem, wherein the dividing may be a recursive process, that is, a solving process is sorted out from a highest level to form the plurality of solving steps, and then each solving step is logically divided to form solving substeps corresponding to the solving step until all the solving steps are logically divided; and
assigning a unique category number to each category of the key problem stem descriptions, the non-key problem stem descriptions, the key knowledge point descriptions, the non-key knowledge point descriptions, solving step descriptions, and non-solving step descriptions, and recording a subordinate relationship between each description and a category of the description.

3. The method for enabling visualization of and intelligently guiding general problem-solving processes according to claim 1, wherein the atomic description set generation specifically comprises:
collecting and sorting out various problems and a plurality of solving steps and related knowledge points corresponding to each problem, and saving problem stems, the solving steps, and the related knowledge points in a computer-processable manner to form a problem data set;
dividing the problem data set into three parts: a training set, a test set, and a to-be-processed problem set;
preprocessing and then performing semantic role labeling on the problem stems, solving steps, and related knowledge points in the training set and the test set, wherein meanings of labeled categories comprise a key problem stem description, non-key problem stem description, key knowledge point description, non-key knowledge point description, solving step description, and non-solving step description;
training a semantic role labeling model by using the training set, checking a training effect by using the test set, and stopping training when a specific threshold is reached for the training set;
performing semantic role labeling on the to-be-processed problem set by using the trained model; and
assigning a unique category number to each semantic role labeling category and recording a subordinate relationship between each semantic role label and a category of the semantic role label.

4. The method for enabling visualization of and intelligently guiding general problem-solving processes according to claim 2, wherein the system relationship set generation specifically comprises:
designing the description classification rule based on the problem stem of the problem, the knowledge points involved in the problem, and the solving steps of the problem, classifying the descriptions in the atomic description set, and generating a relationship between each description in the atomic description set and each category; and
selecting two descriptions from the atomic description set, determining a relationship between the two selected descriptions, and repeating the selecting until a relationship between any two descriptions in the atomic description set is determined; or
the system relationship set generation specifically comprises:
classifying the descriptions in the atomic description set;
determining a relationship between any two descriptions in each category;
determining a relationship between any two categories;
selecting two descriptions m1 and m2 in any two different categories A and B, respectively, wherein m1 belongs to the category A and m2 belongs to the category B, and if a relationship between the category A and category B is r, a relationship between m1 and m2 is also r, and adding the relationship r between m1 and m2 to the system relationship set; and
repeating the foregoing steps until a size of the system relationship set no longer changes.

5. The method for enabling visualization of and intelligently guiding general problem-solving processes according to claim 4, wherein the basic graphic set generation specifically comprises:
designing a respective basic graphic for each of the key problem stem descriptions, the non-key problem stem descriptions, the key knowledge point descriptions, the non-key knowledge point descriptions, the solving step descriptions, the non-solving step descriptions, and other categories of descriptions obtained based on the description classification rules, assigning a globally unique number to each graphic, and saving one-to-one correspondences between each description and a corresponding graphic and between each category and a corresponding graphic; or
designing basic graphics of various descriptions and categories and saving them in a graphic library in advance, selecting basic graphics corresponding to the obtained descriptions and categories from the graphic library, assigning a globally unique number to each of the selected graphics, and saving relationships between each description and a corresponding graphic and between each category and a corresponding graphic.

6. The method for enabling visualization of and intelligently guiding general problem-solving processes according to claim 3, wherein the system relationship set generation specifically comprises:
designing the description classification rule based on the problem stem of the problem, the knowledge points involved in the problem, and the solving steps of the problem, classifying the descriptions in the atomic description set, and generating a relationship between each description in the atomic description set and each category; and
selecting two descriptions from the atomic description set, determining a relationship between the two selected descriptions, and repeating the selection process until a relationship between any two descriptions in the atomic description set is determined; or
the system relationship set generation specifically comprises:
classifying the descriptions in the atomic description set;
determining a relationship between any two descriptions in each category;
determining a relationship between any two categories;
selecting two descriptions m1 and m2 in any two different categories A and B, respectively, wherein m1 belongs to the category A and m2 belongs to the category B, and if a relationship between the category A and category B is r, a relationship between m1 and m2 is also r, and adding the relationship r between m1 and m2 to the system relationship set; and
repeating the foregoing steps until a size of the system relationship set no longer changes.

7. The method for enabling visualization of and intelligently guiding general problem-solving processes according to claim 6, wherein the basic graphic set generation specifically comprises:
designing a respective basic graphic for each of the key problem stem descriptions, the non-key problem stem descriptions, the key knowledge point descriptions, the non-key knowledge point descriptions, the solving step descriptions, the non-solving step descriptions, and other categories of descriptions obtained based on the description classification rules, assigning a globally unique number to each graphic, and saving one-to-one correspondences between each description and a corresponding graphic and between each category and a corresponding graphic; or
designing basic graphics of various descriptions and categories and saving them in a graphic library in advance, selecting basic graphics corresponding to the obtained descriptions and categories from the graphic library, assigning a globally unique number to each of the selected graphics, and saving relationships between each description and a corresponding graphic and between each category and a corresponding graphic.

8. The method for enabling visualization of and intelligently guiding general problem-solving processes according to claim 1, wherein the feedback prompt set generation specifically comprises:
checking whether each relationship in a relationship name set can be independent of the problem and uniformly use a feedback prompt; and if yes, using a feedback prompt that has been designed for the problem or redesigning the feedback prompt of the relationship; or if no, designing respective feedback prompts for each relationship in the category; wherein display forms of the designed feedback prompts comprise but are not limited to text, graphics, images, formulas, expressions, symbols, strings, audio, videos, and animations, and a relationship can have any number of feedback prompts.

9. The method for enabling visualization of and intelligently guiding general problem-solving processes according to claim 1, wherein the user relationship set generation specifically comprises:
displaying all or some of graphics in the basic graphic set and corresponding atomic descriptions on the human-machine interaction interface based on one-to-one correspondences between the atomic description set and the basic graphic set;
performing, by the user, operations on the basic graphics displayed on the human-machine interaction interface to create or update the relationships between the basic graphics; and
determining, based on the relationships between the basic graphics edited by the user and the one-to-one correspondences between the atomic description set and the basic graphic set, relationships between the descriptions edited by the user, to form the user relationship set.

10. The method for enabling visualization of and intelligently guiding general problem-solving processes according to claim 1, wherein the comparison specifically comprises:
comparing, by a system, the user relationship set with the system relationship set when the user performs operations on the basic graphics, to obtain the comparison result; and
determining, based on the comparison result and the feedback prompt set, categories, a number, positions, and display modes of feedback prompts to be displayed, and displaying the feedback prompts on the human-machine interaction interface with reference to user preference settings and problem difficulty settings.

11. The method for enabling visualization of and intelligently guiding general problem-solving processes according to claim 2, wherein the comparing the system relationship set and user relationship set comprises: if the user relationship set on the current human-machine interaction interface is a subset of the system relationship set, completing problem-solving.

12. The method for enabling visualization of and intelligently guiding general problem-solving processes according to claim 3, wherein the comparing the system relationship set and user relationship set comprises: if the user relationship set on the current human-machine interaction interface is a subset of the system relationship set, completing problem-solving.

13. An apparatus for enabling visualization of and intelligently guiding general problem-solving processes, comprising: an atomic description set generation module, a basic graphic set generation module, a system relationship set generation module, a feedback prompt set generation module, a user relationship set generation module, a comparison module, and a human-machine interaction module; wherein
the atomic description set generation module is configured to generate key descriptions and non-key descriptions of each part based on a problem stem of a problem, knowledge points involved in the problem, and solving steps of the problem to form an atomic description set;
the basic graphic set generation module is configured to generate a basic graphic corresponding to each description based on the descriptions in the atomic description set to form a basic graphic set based on all the basic graphics;
the system relationship set generation module is configured to generate relationships between the descriptions in the atomic description set based on the problem stem of the problem, the knowledge points involved in the problem, and the solving steps of the problem to form a system relationship set;
the feedback prompt set generation module is configured to generate feedback prompts corresponding to each relationship in the system relationship set based on the problem stem of the problem, the knowledge points involved in the problem, and the solving steps of the problem to form a feedback prompt set;
the user relationship set generation module is configured to perform, by a user, operations on the basic graphics displayed on a human-machine interaction interface to create relationships between the basic graphics, to form a user relationship set;
the comparison module is configured to compare the system relationship set and user relationship set, and provide feedback to the human-machine interaction interface based on a comparison result; and
the human-machine interaction module is configured to display the atomic description set generation module, basic graphic set generation module, system relationship set generation module, feedback prompt set generation module, user relationship set generation module, and comparison module, and click, drag, move, connect, zoom, and delete the basic graphics on the human-machine interaction interface by the user.
